(19) United States
(12) Patent Application Publication
(10) Pub. No.: US 2023/0340303 A1
(43) Pub. Date: Oct. 26, 2023

(54) Release Liners and Articles Including Them

(71) Applicant: 3M INNOVATIVE PROPERTIES COMPANY, St. Paul, MN (US)

(72) Inventors: Jitendra S. Rathore, Woodbury, MN (US); Maria A. Appeaning, St. Paul, MN (US)

(21) Appl. No.: 18/008,539

(22) PCT Filed: May 17, 2021
(86) PCT No.: PCT/IB2021/054219

§ 371 Date: Dec. 6, 2022

Related U.S. Application Data
(60) Provisional application No. 63/040,206, filed on Jun. 17, 2020.

(51) Int. Cl. C09J 7/40

(52) U.S. Cl. CPC C09J 7/401; C09J 2483/005; C09J 2429/005

(57) ABSTRACT

Release liners that can be included in various adhesive products are provided. A first release liner is a layer of a composition including a) a polymeric material having at least one hydrogen atom covalently bonded to an oxygen atom, a nitrogen atom, or a sulfur atom; and b) a silicone polyether comprising at least one of polyoxoethylene units or polyoxopropylene units. A second release liner includes a substrate and a coating of the above composition disposed on a major surface of the substrate. The present disclosure also provides an article including one of the above release liners and an adhesive layer disposed on a major surface of the release liner. The composition of the release liner can advantageously be dissolved and optionally recycled.

### BACKGROUND

Adhesive tape comes in many varieties such as, for example, single-sided or double-sided adhesive tape that is usually wound into a roll. Some adhesive tapes have a backing layer and an adhesive layer securely bonded to the backing layer. To facilitate unrolling of the adhesive tape, the side of the backing layer opposite the adhesive layer can have a release layer.

Some adhesive tapes are adhesive transfer tapes with an adhesive layer adjacent a release liner that protects the adhesive layer and that is removed prior to securely bonding the adhesive layer to a substrate. The release liner has a backing layer and a release layer on one or both surfaces of the backing layer. The release liner is positioned adjacent to the adhesive layer such that there is a release layer between the adhesive layer and the backing layer of the release liner.

Release layers have been prepared by dissolving the release components in solvent, coating the resulting solution onto a surface of the backing layer, and drying to evaporate the solvent. One example of a release coating formed using a conventional solvent-based process is found in U.S. Pat. No. 2,532,011 (Dahlquist et al.). Solvent-based processes, however, have become increasingly less desirable due to special handling requirements and environmental concerns.

### SUMMARY

Release liners that can be included in various adhesive tape products are provided.

In a first aspect, a release liner is provided. The release liner comprises a layer of a composition comprising a) a polymeric material having at least one hydrogen atom covalently bonded to an oxygen atom, a nitrogen atom, or a sulfur atom; and b) a silicone polyether comprising at least one of polyoxoethylene units or polyoxopropylene units.

In a second aspect, another release liner is provided. The release liner comprises a substrate having a first major surface and an opposing second major surface; and a coating disposed on at least a portion of the first major surface of the substrate. The coating comprises a composition comprising a) polymeric material having at least one hydrogen atom covalently bonded to an oxygen atom, a nitrogen atom, or a sulfur atom; and b) a silicone polyether comprising at least one of polyoxoethylene units or polyoxopropylene units.

In a third aspect, an article is provided. The article comprises a release liner according to the first aspect or the second aspect. The release liner has a first major surface comprising the layer or the coating; and an adhesive layer disposed on at least a portion of the first major surface of the release liner.

The present disclosure can provide truly recyclable release layers or coatings due to a lack of covalent crosslinks between components. Furthermore, non-covalent interactions between the polymeric material and the silicone polyether tend to minimize silicone transfer to adjacent adhesives, providing excellent release layers/coatings for paper-based products.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a schematic of a vertical cross-section of an exemplary release liner according to the present disclosure.

FIG. 2 is a schematic of a vertical cross-section of another exemplary release liner according to the present disclosure.

FIG. 3A is a schematic of a vertical cross-section of an exemplary article according to the present disclosure.

FIG. 3B is a schematic of a vertical cross-section of another exemplary article according to the present disclosure.

The various layers shown in the above figures are not drawn to scale and the dimensions shown in the figures are only for illustrative purposes.

### DETAILED DESCRIPTION

### Glossary

As used herein, “a”, “an”, and “the” are used interchangeably and mean one or more.

The term “and/or” is used to indicate that one or both stated cases may occur, for example A and/or B includes, (A and B) and (A or B). That is, it is used to mean A alone, B alone, or both A plus B.

The term “alkyl” refers to a monovalent group that is a radical of an alkane. The alkyl can have at least 1, at least 2, at least 3, at least 4, at least 6, or at least 10 carbon atoms and can have up to 32 carbon atoms, up to 24 carbon atoms, up to 20 carbon atoms, up to 18 carbon atoms, up to 12 carbon atoms, up to 10 carbon atoms, up to 6 carbon atoms, or up to 4 carbon atoms. The alkyl can be linear, branched, cyclic, or a combination thereof. A linear alkyl has at least one carbon atoms while a cyclic or branched alkyl has at least 3 carbon atoms. In some embodiments, if there are greater than 12 carbon atoms, the alkyl is branched. Examples of linear alkyl groups include methyl, ethyl, n-propyl, n-butyl, n-pentyl, n-hexyl, n-heptyl, and n-octyl groups. Examples of branched alkyl groups include iso-propyl, iso-butyl, sec-butyl, t-butyl, neopentyl, iso-pentyl, and 2,2-dimethylpropyl groups. Examples of cycloalkyl groups include cyclopropyl, cyclobutyl, cyclopentyl, and cyclohexyl.

The term “alkoxy” refers to a monovalent group of formula —OW where W is an alkyl as defined above.

The term “alkylene” refers to a divalent group that is a radical of an alkane. The alkylene can have at least 2, at least 3, at least 4, at least 6, or at least 10 carbon atoms and can have up to 32 carbon atoms, up to 24 carbon atoms, up to 20 carbon atoms, up to 18 carbon atoms, up to 12 carbon atoms, up to 10 carbon atoms, up to 6 carbon atoms, or up to 4 carbon atoms. The alkylene can be linear, branched, cyclic, or a combination thereof. A linear alkylene has at least one carbon atoms while a cyclic or branched alkylene has at least 3 carbon atoms. In some embodiments, if there are greater than 12 carbon atoms, the alkyl is branched. Examples of linear alkylene groups include methylene, ethylene, n-propylene, n-butylene, n-pentylene, n-hexylene, n-heptylene, and n-octylene groups. Examples of branched alkyl groups include iso-propylene, iso-butylene, sec-butylene, t-butylene, neo-pentylene, iso-pentylene, and 2,2-dimethylpropylene groups.

The term “coating” as used herein means a dry thin layer of a material or composition.

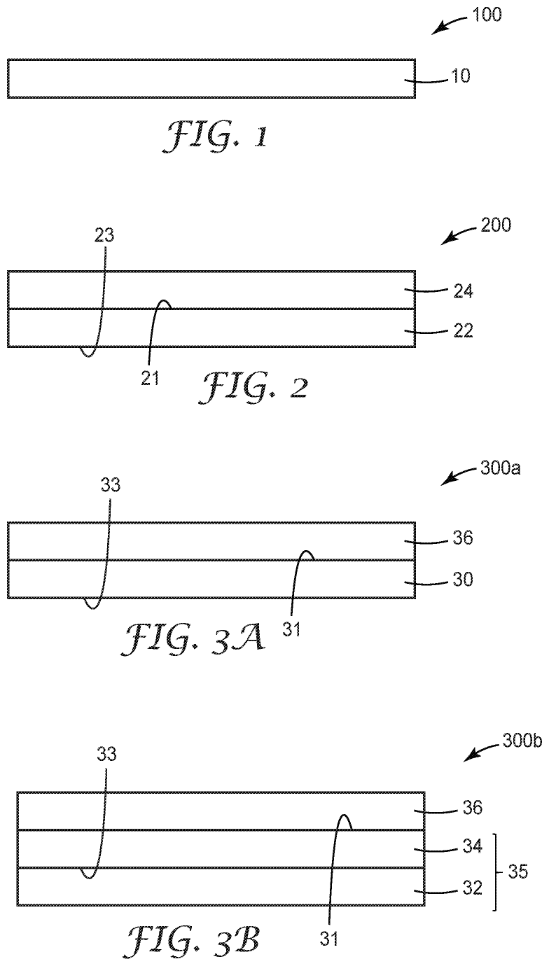

In a first aspect, a release liner is provided. Referring to FIG. 1, the release liner 100 comprises a layer 10 of a composition. The composition comprises a) a polymeric material having at least one hydrogen atom covalently bonded to an oxygen atom, a nitrogen atom, or a sulfur atom; and b) a silicone polyether comprising at least one of polyoxoethylene units or polyoxopropylene units. Such a layer of the composition by itself can act as a release liner without requiring any further supporting substrate (e.g., paper or polymeric film). In certain embodiments, the layer is self-supporting.

The layer can be formed by any suitable method. In certain embodiments, a medium solids content solution or dispersion of the composition is prepared and applied to a major surface of a support substrate (e.g., a polyethylene terephthalate film), followed by drying (e.g., using a thermal oven) to form the (dried) coating. The layer is typically then removed from the support substrate, such as by peeling the layer apart from the major surface of the support substrate. By “medium solids” is meant 9 wt. % solids or more, based on the total weight of the solution or dispersion, 10 wt. % solids or more, 11 wt. % solids or more, 12 wt. % solids or more, 13 wt. % solids or more, 14 wt. % solids or more, 15 wt. % solids or more, 16 wt. % solids or more, 17 wt. % solids or more, 18 wt. % solids or more, or 19 wt. % solids or more; and 30 wt. % solids or less, 29 wt. % solids or less, 28 wt. % solids or less, 27 wt. % solids or less, 26 wt. % solids or less, 25 wt. % solids or less, 24 wt. % solids or less, 23 wt. % solids or less, 22 wt. % solids or less, 21 wt. % solids or less, or 20 wt. % solids or less, based on the total weight of the solution or dispersion. In most embodiments, the solution or dispersion is aqueous (e.g., including water as more than 50% by weight to up to 100% by weight of the total solvent in the solution or dispersion). In preferred embodiments, the solution or dispersion contains less than 5 wt. % organic solvents, such as less than 4 wt. %, less than 3 wt. %, less than 2 wt. %, less than 1 wt. %, or less than 0.5 wt. % of any organic solvents.

In a second aspect, another release liner is provided. Referring to FIG. 2, the release liner 200 comprises a substrate 22 having a first major surface 21 and an opposing second major surface 23; and a coating 24 disposed on at least a portion of the first major surface of the substrate. The coating comprises a composition comprising a) polymeric material having at least one hydrogen atom covalently bonded to an oxygen atom, a nitrogen atom, or a sulfur atom; and b) a silicone polyether comprising at least one of polyoxoethylene units or polyoxopropylene units. Such release liners are typically formed by applying a low solids solution or dispersion of the composition onto the substrate surface, followed by drying (e.g., using a thermal oven) to form the (dried) coating. By “low solids” is meant 8 wt. % solids or less, based on the total weight of the solution or dispersion, 7 wt. % solids or less, 6 wt. % solids or less, 5 wt. % solids or less, 4 wt. % solids or less, 3 wt. % solids or less, or 2 wt. % solids or less; and 0.5 wt. % solids or greater, based on the total weight of the solution or dispersion. In most embodiments, the solution or dispersion is aqueous.

Any suitable backing substrate can be used. In some applications, the substrate can be constructed of paper, polymeric material, metal, or a combination thereof The substrate is usually flexible and is suitable for winding into a roll. In some embodiments, the substrate comprises paper. The substrate can include multiple layers of different materials. In some embodiments, the substrate comprises a polymeric film. In many embodiments the substrate includes a polymeric film that is prepared from polyester (e.g., polyethylene terephthalate, polybutylene terephthalate, polycaprolactone, and polylactic acid), polyolefin (e.g., polyethylene, polypropylene (e.g., isotactic polypropylene)), polystyrene, polyvinylidene fluoride, polyvinyl alcohol, polyvinyl acetate, ethyl cellulose, cellulose acetate, or copolymers thereof The thermoplastic films can contain oriented polymeric material in one or two directions such as, for example, biaxially oriented polypropylene. Each major surface of the substrate can be treated, if desired, to enhance chemical and/or physical anchorage of the release coating to the substrate by application of primer, corona treatment, flame treatment, ozone treatment, or the like. Such treatments assist in ensuring that the release coating is attached (e.g., permanently attached or adhered) to the substrate and not easily removed or separated from the substrate.

It has been discovered that silicone polyether materials having a polyoxoethylene or polyoxopropylene content function as good release components (e.g., exhibit a balance of low release force and high readhesion) when included with a hydrophilic polymeric material (e.g., having at least one hydrogen atom covalently bonded to an oxygen atom, a nitrogen atom, or a sulfur atom). Such silicone polyether materials are typically water soluble.

Preferably, each of the polymeric material and the silicone polyether remain uncrosslinked with themselves and each other in the layer or coating of the release liner. Preferably, the polymeric material and the silicone polyether are not covalently bonded to each other. Advantageously, the layer or coating of the composition comprising the polymeric material and the silicone polyether that are not covalently bonded together can be dissolved and recycled. Without wishing to be bound by theory, it is believed that the polymeric material and the silicone polyether interact via hydrogen bonding. Further, hydrogen bonding between at least a portion of the polymeric material and at least a portion of the silicone polyether is thought to assist in advantageously maintaining the silicone polyether in the composition instead of transferring into an adjacent adhesive when the release liner is in contact with an adhesive.

A hydrogen bond is an attractive force, or bridge, occurring in polar compounds in which a hydrogen atom of one molecule or functional group is attracted to unshared electrons of another. The hydrogen atom is the positive end of one polar molecule or functional group (otherwise known as a hydrogen bond donor) and forms a linkage with the electronegative end of another molecule or functional group (otherwise known as a hydrogen bond acceptor). Hydrogen bonds generally occur between a donor hydrogen (H) atom covalently bound to a highly electronegative atom such as nitrogen (N), oxygen (O), sulfur (S), or fluorine (F), and an acceptor, such as the free electrons on the oxygen atom of an ether group. Such a hydrogen atom is attracted to the electrostatic field of another highly electronegative atom nearby. In some embodiments, the layer or the coating is writable. By “writable” is meant the property of being receptive to inks, dyes, print, toner, marks, or the like. The layer of coating may be writable due to having at least one hydrophilic component, which allows ink, etc., to wet out properly. Suitable (hydrophilic) polymeric materials having at least one hydrogen atom covalently bonded to an oxygen atom, a nitrogen atom, or a sulfur atom include for instance and without limitation, polyvinyl alcohol, polyvinyl acetate, ethylene vinyl acetate, ethylene vinyl alcohol, polyvinylpyrrolidone, polyvinylpyridine, poly(N-isopropylacrylamide), polyacrylamide, poly(-ethyl 2-oxazoline), poly(vinylamine) hydrochloride, poly(methacrylic acid), poly(styrenesulphonic acid), and poly(vinyl phosphoric acid).

Polyvinyl acetate is a polymer that is known and available commercially. The glass transition temperature (T_{g}) of the polyvinyl acetate polymer is typically at least 25, 30, 35 or 40° C. The T_{g} of the polyvinyl acetate is typically no greater than 50 or 45° C. The polyvinyl acetate generally has a low level of hydrolysis. The polymerized units of the polyvinyl acetate polymer that are hydrolyzed to units of vinyl alcohol is generally no greater than 10, 9, 8, 7, 6, 5, 4, 3, 2, 1 or 0.5 mol % of the polyvinyl acetate polymer. Polyvinyl acetate polymers are commercially available from various suppliers including Wacker (Adrian, MI) under the trade designation “VINNAPAS”.

Polyvinyl alcohol (PVA) is another polymer that is known and available commercially. Typically, polyvinyl alcohol is prepared by hydrolyzing acetate groups to hydroxyl groups. For example, the polyvinyl alcohol can include up to 50 percent polyvinyl acetate, derivatives thereof, and mixtures of polyvinyl alcohol and its derivatives. The degree of hydrolysis of polyvinyl alcohol is from 50 to 100 percent, or 70 to 100 percent, or 85 to 100 percent. One suitable polyvinyl alcohol is KURARAY PVA 235, which is a trade designation for a polyvinyl alcohol polymer that is commercially available from Kuraray Co. LTD, Japan.

Ethylene vinyl acetate is a copolymer that is known and available commercially. Ethylene vinyl acetate range in vinyl acetate content from 7.5 to 33 wt. %. Ethylene vinyl acetate also generally has a low level of hydrolysis. The polymerized units of the ethylene vinyl acetate copolymer that are hydrolyzed to units of ethylene vinyl alcohol is generally no greater than 10, 9, 8, 7, 6, 5, 4, 3, 2, 1 or 0.5 mol % of the ethylene vinyl acetate copolymer. Some suitable commercially available ethylene vinyl acetate copolymers include those from Dow (Midland, MI) under the trade designation “ELVAX”, such as ELVAX 40 W, ELVAX 150, and ELVAX 410, and from Arlenxeo (The Hague, Netherlands) under the trade designation “LEVAMELT”.

Ethylene vinyl alcohol is generally formed from ethylene vinyl acetate copolymers after saponification. The ethylene vinyl acetate copolymer comprises ethylene and vinyl acetate monomers. After saponification of the ethylene vinyl acetate copolymer, the vinyl acetate units can be chemically modified to vinyl alcohol units. Other monomer components can also be present in the saponified ethylene-vinyl acetate copolymer in such amounts not to impair the hydrophilicity of the hydrophilic membrane. The ethylene vinyl alcohol copolymer can be of various types including, for example, random copolymers, block copolymers, graft copolymers, and the like, or combinations thereof. Similarly, the selection of ethylene vinyl alcohol can depend on the structure and molecular weight of the ethylene vinyl acetate formed prior to saponification. In some embodiments, the degree of saponification of the ethylene vinyl acetate copolymer can be at least about 40 mole percent based on the vinyl alcohol units in the copolymer. In other embodiments, the degree of saponification of the ethylene vinyl acetate copolymer can be at least about 45 mole percent, at least about 65 mole percent, at least about 85 mole percent, or at least about 95 mole percent of the vinyl alcohol units in the copolymer. One commercially available suitable polymeric material can be obtained under the trade designation “RS-2117” from Kuraray America Inc. (Houston, TX) which is a water-soluble ethylene vinyl alcohol (EVA) copolymer.

Polyvinylpyrrolidone is a commercially available water-soluble polymer made from the monomer N-vinylpyrrolidone. Polyvinylpyridine is a commercially available water-soluble polymer, with a preferred polyvinylpyridine being poly(4-vinylpyridine). Polyvinyl(N-isopropylacrylamide) is a commercially available water-soluble polymer made from N-isopropylacrylamide via free-radical polymerization. Polyacrylamide is a commercially available water-soluble polymer made from acrylamide subunits, preferably having a linear structure. Poly(2-ethyl-2-oxazoline) is a commercially available water-soluble polymer made from cationic ring-opening polymerization of 2-ethyl-2-oxazoline monomer. Poly(vinylamine) hydrochloride is a commercially available water-soluble all-primary polymer made from vinylamine subunits. Poly(methacrylic acid) is a commercially available water-soluble vinyl-functional polymer made from methacrylic acid monomer, and frequently available as a sodium salt. Poly(styrenesulphonic acid) is a commercially available water-soluble vinyl-functional polymer made from styrenesulphonic acid monomer, and frequently available as a sodium salt. Poly(vinyl phosphoric acid) is a commercially available water-soluble phosphate ester-functionalized polymer made from vinyl phosphoric acid monomer, and frequently available as a sodium salt.

Most preferred polymeric materials include polyvinyl acetate and polyvinyl alcohol, due to abundant hydrogen bonding capabilities of these materials.

In the composition, the polymeric material is present in an amount of 90 wt. % to 99.5 wt. %, based on the weight of the combined polymeric material and silicone polyether. As such, any other components present in the composition, such as additives, are not included in this weight percentage range. Stated another way, in some embodiments, the polymeric material is present in an amount of 90 wt. % or greater, based on the total weight of the polymeric material and the silicone polyether, 90.5 wt. % or greater, 91 wt. % or greater, 91.5 wt. % or greater, 92 wt. % or greater, 92.5 wt. % or greater, 93 wt. % or greater, 93.5 wt. % or greater, 94 wt. % or greater, 94.5 wt. % or greater, or 95 wt. % or greater; and 99.5 wt. % or less, based on the total weight of the polymeric material and the silicone polyether, 99 wt. % or less, 98.5 wt. % or less, 98 wt. % or less, 97.5 wt. % or less, 97 wt. % or less, 96.5 wt. % or less, 96 wt. % or less, or 95.5 wt. % or less.

The polymeric material and silicone polyether together make up 90 wt. % or greater of the overall composition (e.g., including additives), based on the total weight of the composition, 91 wt. % or greater, 92 wt. % or greater, 93 wt. % or greater, 94 wt. % or greater, 95 wt. % or greater, 96 wt. % or greater, 97 wt. % or greater, 98 wt. % or greater, 99 wt. % or greater, or 99.5 wt. % or greater, based on the total weight of the composition; and 100 wt. % or less of the composition.

It is noted above that the silicone polyether contains at least one of polyoxoethylene units or polyoxopropylene units. Hence, the silicone polyether may contain only polyoxoethylene units, only polyoxopropylene units, or a combination of both polyoxoethylene units and polyoxopropylene units. In some embodiments, the silicone polyether is composed of 40 wt. % or greater, 45 wt. % or greater, 50 wt. % or greater, 55 wt. % or greater, 60 wt. % or greater, 65 wt. % or greater, 77 wt. % or greater, 80 wt. % or greater, 82 wt. % or greater, 85 wt. % or greater, 87 wt. % or greater, or even 90 wt. % or greater of at least one of polyoxoethylene units or polyoxopropylene units; and 99 wt. % or less, 98 wt. % or less, 97 wt. % or less, 96 wt. % or less, 95 wt. % or less, 94 wt. % or less, 93 wt. % or less, 92 wt. % or less, or 91 wt. % or less of at least one of polyoxoethylene units or polyoxopropylene units. In some embodiments, the silicone polyether preferably contains 75 wt. % or greater of at least one of polyoxoethylene units or polyoxopropylene units.

In some embodiments, the silicone polyether has the structure of Formula (I) or Formula (II) below:

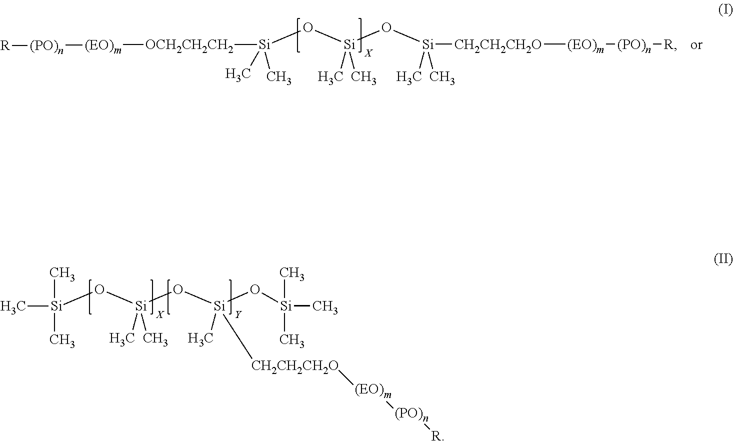

In each of Formula (I) and Formula (II), R is independently selected from C1-C10 linear or branched alkyl groups, methoxy, ethoxy, isopropoxy, isobutoxy, halogens selected from Cl, Br, and I, C6-C12 aromatic groups, hydroxy, —CH₂—OH, —CH₂CH₂—OH, or —CH₂CH₂—OCH₃; EO is —(CH₂—CH₂—O)—; PO is —(CH₂—CHCH₃—O)—; n and m are independently selected from integers between 0 and 500, with the proviso that at least one n or at least one m is selected from integers between 1 and 500; and x and y are independently selected from integers between 1 and 5000.

In some embodiments, n and m are independently selected from integers between 10 and 200 or between 20 and 60. In some embodiments, x and y are independently selected from integers between 20 and 1000 or between 50 and 200.

Suitable C1-C10 linear or branched alkyl groups (i.e., having 1 to 10 carbon atoms) may include at least one of methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, or norbornyl. In some embodiments, the linear or branched alkyl groups are C1-C6 groups, C1-C4 groups, or C1-C3 groups. Suitable C6-C12 aromatic groups (i.e., having 6 to 12 carbon atoms) may include at least one of phenyl, naphthyl, biphenyl, phenanthryl, or anthracyl. In some embodiments, R is independently selected from methyl, ethyl, methoxy, ethoxy, or hydroxy.

In select embodiments, the silicone polyether comprises a poly(dimethylsiloxane-co-ethyleneoxide) AB block copolymer with 75 wt. %, 82 wt. %, or 85 wt. % polyoxoethylene units.

In the composition, the silicone polyether is present in an amount of 0.5 wt. % to 10 wt. %, based on the weight of the combined polymeric material and silicone polyether. Again, any other components present in the composition, such as additives, are not included in this weight percentage range. Stated another way, in some embodiments, the silicone polyether is present in an amount of 0.5 wt. % or greater, based on the total weight of the polymeric material and the silicone polyether, 1 wt. % or greater, 1.5 wt. % or greater, 2 wt. % or greater, 2.5 wt. % or greater, 3 wt. % or greater, 3.5 wt. % or greater, 4 wt. % or greater, 4.5 wt. % or greater, or 4.5 wt. % or greater; and 10 wt. % or less, based on the total weight of the polymeric material and the silicone polyether, 9.5 wt. % or less, 9 wt. % or less, 8.5 wt. % or less, 8 wt. % or less, 7.5 wt. % or less, 7 wt. % or less, 6.5 wt. % or less, 6 wt. % or less, or 5.5 wt. % or less.

Any embodiment of the composition may further include a silicone compound, a fluorosilicone compound, or both, as an additive. Suitable silicone and fluorosilicone compounds include for instance and without limitation, trimethylsiloxy containing polydimethylsiloxanes, polyoctylmethylsiloxane, alkyl (C10-C18) methylsiloxane dimethylsiloxane copolymers, vinyl containing polydimethylsiloxanes, diphenylsiloxane-dimethylsiloxane copolymers, polyphenylmethylsiloxane, trifluoropropylmethylsiloxane-dimethylsiloxane copolymer, polytrifluoropropylmethylsiloxane, nonafluorohexylmethylsiloxane-dimethylsiloxane copolymer, polynonafluorohexylmethylsiloxane, vinylmethylsiloxane-dimethylsiloxane copolymers, hydride containing polydimethylsiloxanes, aminopropyl containing polydimethylsiloxanes, epoxypropoxypropyl containing polydimethylsiloxanes, carbinol (hydroxyl) containing polydimethylsiloxanes, methacryloxypropyl containing polydimethylsiloxanes, or any combination thereof.

The silicone and/or fluorosilicone compounds may be present in an amount of 0.01 wt. % or greater, based on the total weight of the composition; and up to 0.025 wt. %, up to 0.05 wt. %, up to 0.1 wt. %, up to 0.15 wt. %, up to 0.2 wt. %, based on the total weight of the composition.

Any embodiment of the composition may further include a wetting agent to assist in reducing the surface tension of the composition, thereby allowing the composition to wet-out the surface of the substrate in a relatively continuous coating. Examples of wetting agents include surfactants, detergents, and soaps. One preferred type of wetting agent is a detergent, most preferably a low bubble or foam generating detergent such as a dishwashing detergent. Detergents include, for example, sodium soaps of fatty acids, and synthetic detergents such nonionic, cationic, and anionic compounds. Representative examples of synthetic detergents include linear alkyl sulfonates (LAS) and alkyl benzene sulfonates (ABS). The wetting agent may be present in an amount of 0.01 wt. % or greater, based on the total weight of the composition; and up to 0.025 wt. %, up to 0.05 wt. %, up to 0.1 wt. %, up to 0.15 wt. %, up to 0.2 wt. %, based on the total weight of the composition.

In a third aspect, an article is provided. The article comprises a release liner according to the first aspect or the second aspect. The release liner has a first major surface comprising the layer (e.g., of the first aspect) or the coating (e.g., of the second aspect); and an adhesive layer disposed on at least a portion of the first major surface of the release liner. Referring to FIG. 3A, in some embodiments, the article 300a comprises a release liner 30 that is composed of a layer of release material. The release liner 30 has a first major surface 31 (and a second major surface 33); and an adhesive layer 36 disposed on at least a portion of the first major surface 31 of the release liner 30. Referring to FIG. 3B, in some embodiments, the article 300b comprises a release liner 35 having a first major surface 31 comprising a coating 34; and an adhesive layer 36 disposed on at least a portion of the first major surface of the release liner. In the embodiment of FIG. 3B, the release liner 35 further comprises a second major surface 33 attached to a substrate 32. The coating 34 is attached more strongly to the substrate (e.g., a backing layer) 32 than to the adhesive layer 36. As such, the coating 34 can be released from the adhesive layer 36 but not from the substrate 32 if a rolled-up article 300b (e.g., a roll of adhesive tape) is subsequently unrolled. If desired, other optional layers not shown in FIG. 3B can be included. For example, there can be a primer layer between the substrate 32 and the coating 34.

Any suitable adhesive layer can be used. In certain embodiments, the adhesive layer comprises an acrylic adhesive, a silicone adhesive, a rubber adhesive, or a urethane adhesive. In some embodiments, the adhesive layer comprises a pressure sensitive adhesive. Pressure-sensitive adhesives (PSAs) are well known to one of ordinary skill in the art to possess properties including the following: (1) aggressive and permanent tack, (2) adherence with no more than finger pressure, (3) sufficient ability to hold onto an adherend, and (4) sufficient cohesive strength to be removed cleanly from the adherend. Exemplary pressure sensitive adhesives include a natural rubber based adhesive, a synthetic rubber based adhesive, a poly(methyl acrylate) based adhesive, a polyurethane based adhesive, or a silicone based adhesive. As used herein “based” means contains at least 50% weight, based on the total weight of the adhesive. The balance of the adhesive may include additives such as tackifiers, plasticizers, oils, or fillers.

The adhesive can be in the form of a film or foam. In some embodiments, the adhesive layer is a single layer. In other embodiments, the adhesive layer is one layer of a multilayer adhesive construction such as a double sided adhesive tape. For example, the multilayer adhesive tape can have a first adhesive skin layer, a second adhesive skin layer, and a core layer positioned between the first adhesive skin layer and the second adhesive skin layer. The core layer is often a foam backing layer and can be an adhesive or non-adhesive foam. In another example, the multilayer adhesive tape can have a first adhesive layer, a film backing, and a second adhesive layer. The film backing can be an adhesive or non-adhesive layer.

Various embodiments are provided that include release liners and articles.

In a first embodiment, the present disclosure provides a release liner. The release liner comprises a layer of a composition comprising a) a polymeric material having at least one hydrogen atom covalently bonded to an oxygen atom, a nitrogen atom, or a sulfur atom; and b) a silicone polyether comprising at least one of polyoxoethylene units or polyoxopropylene units.

In a second embodiment, the present disclosure provides another release liner. The release liner comprises a substrate having a first major surface and an opposing second major surface; and a coating disposed on at least a portion of the first major surface of the substrate. The coating comprises a composition comprising a) polymeric material having at least one hydrogen atom covalently bonded to an oxygen atom, a nitrogen atom, or a sulfur atom; and b) a silicone polyether comprising at least one of polyoxoethylene units or polyoxopropylene units.

In a third embodiment, the present disclosure provides a release liner according to the first embodiment or the second embodiment claim 1 or claim 2, wherein the silicone polyether is composed of 75 wt. % or greater, 80 wt. % or greater, 85 wt. % or greater, or 90 wt. %, of at least one of polyoxoethylene units or polyoxopropylene units.

In a fourth embodiment, the present disclosure provides a release liner according to any of the first through third embodiments, wherein the silicone polyether has the structure of Formula (I) or Formula (II):

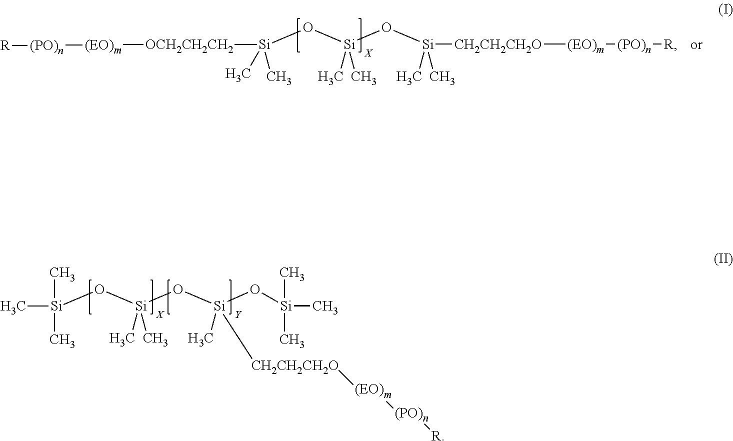

In each of Formula (I) or Formula (II), R is independently selected from C1-C10 linear or branched alkyl groups, methoxy, ethoxy, isopropoxy, isobutoxy, halogens selected from Cl, Br, and I, C6-C12 aromatic groups, hydroxy, —CH₂—OH, —CH₂CH₂—OH, or —CH₂CH₂—OCH₃; EO is —(CH₂—CH₂—O)—; PO is —(CH₂—CHCH₃—O)—; n and m are independently selected from integers between 0 and 500, with the proviso that at least one n or at least one m is selected from integers between 1 and 500; and x and y are independently selected from integers between 1 and 5000.

In a fifth embodiment, the present disclosure provides a release liner according to the fourth embodiment, wherein in each of Formula (I) or Formula (II), n and m are independently selected from integers between 10 and 200 or between 20 and 60.

In a sixth embodiment, the present disclosure provides a release liner according to the fourth embodiment or the fifth embodiment, wherein in each of Formula (I) or Formula (II), x and y are independently selected from integers between 20 and 1000 or between 50 and 200.

In a seventh embodiment, the present disclosure provides a release liner according to any of the fourth through sixth embodiments, wherein in each of Formula (I) or Formula (II), R is independently selected from methyl, ethyl, methoxy, ethoxy, and hydroxy.

In an eighth embodiment, the present disclosure provides a release liner according to any of the first through seventh embodiments, wherein the silicone polyether comprises a poly(dimethylsiloxane-co-ethyleneoxide) AB block copolymer with 75 wt. %, 82 wt. %, or 85 wt. % polyoxoethylene units.

In a ninth embodiment, the present disclosure provides a release liner according to any of the first through eighth embodiments, wherein the silicone polyether is present in an amount of 0.5 wt. % to 10 wt. %, based on the weight of the combined polymeric material and silicone polyether.

In a tenth embodiment, the present disclosure provides a release liner according to any of the first through ninth embodiments, wherein the polymeric material is present in an amount of 90 to 99.5 wt. %, based on the weight of the combined polymeric material and silicone polyether.

In an eleventh embodiment, the present disclosure provides a release liner according to any of the first through tenth embodiments, wherein the polymeric material comprises at least one of polyvinyl alcohol, polyvinyl acetate, ethylene vinyl acetate, or ethylene vinyl alcohol.

In a twelfth embodiment, the present disclosure provides a release liner according to any of the first through eleventh embodiments, wherein the layer or the coating further comprises up to 0.2 wt. % or up to 0.1 wt. % of a silicone compound, a fluorosilicone compound, or both, based on the total weight of the composition.

In a thirteenth embodiment, the present disclosure provides a release liner according to any of the first through tenth embodiments, wherein the layer or the coating further comprises up to 0.2 wt. % or up to 0.1 wt. % of a wetting agent, based on the total weight of the composition.

In a fourteenth embodiment, the present disclosure provides a release liner according to any of the first through thirteenth embodiments, wherein the polymeric material and the silicone polyether are not covalently bonded to each other.

In a fifteenth embodiment, the present disclosure provides a release liner according to any of the first through fourteenth embodiments, comprising hydrogen bonding between at least a portion of the polymeric material and at least a portion of the silicone polyether.

In a sixteenth embodiment, the present disclosure provides a release liner according to any of the first through fifteenth embodiments, wherein the layer or the coating is writable.

In a seventeenth embodiment, the present disclosure provides a release liner according to any of the second through sixteenth embodiments, wherein the substrate is present and comprises paper.

In an eighteenth embodiment, the present disclosure provides a release liner according to any of the second through sixteenth embodiments, wherein the substrate is present and comprises a polymeric film.

In a nineteenth embodiment, the present disclosure provides an article. The article comprises a release liner according to any of the first through eighteenth embodiments. The release liner has a first major surface comprising the layer or the coating; and an adhesive layer disposed on at least a portion of the first major surface of the release liner.

In a twentieth embodiment, the present disclosure provides an article according to the nineteenth embodiment, wherein the adhesive layer comprises an acrylic adhesive, a silicone adhesive, a rubber adhesive, or a urethane adhesive.

In a twenty-first embodiment, the present disclosure provides an article according to the nineteenth embodiment or the twentieth embodiment, wherein the adhesive layer comprises a pressure sensitive adhesive.

### EXAMPLES

Unless otherwise noted or apparent from the context, all parts, percentages, ratios, etc. in the Examples and the rest of the specification are by weight. Table 1 (below) lists materials used in the examples and their sources.

TABLE 1
Materials List

| Abbreviation | Description and Source |
|---|---|
| PDMS 1 | Cat# 792, Poly(dimethylsiloxane-co-ethyleneoxide), AB block copolymer, |
| | said to contain 82% ethyleneoxide (EO) component, obtained from Scientific |
| | Polymer Products, Inc. Ontario, NY. |
| PDMS 2 | GP-70-EO is a 50% silicone solids emulsion of an organo-modified silicone |
| | polymer containing alkyl and alkylaryl side chains from Genesee Polymer |
| | Corporation, Burton, MI |
| PDMS 3 | GP-219 silicone polyol copolymer is a 100% active polyoxyethylene modified |
| | dimethylpolysiloxane block copolymer said to contain 58% silicone |
| | component and 42% ethyleneoxide (EO) component, from Genesee Polymer |
| | Corporation, Burton, MI |
| PDMS 4 | DBE-821, Polyalkylene oxide modified silicones, said to contain 80-85% |
| | ethyleneoxide (EO) component from Gelest Inc, Morrisville, PA |
| WSP-1 | RS-2117 is a water-soluble ethylene vinyl alcohol (EVA) copolymer from |
| | Kuraray America Inc., Houston, TX |
| Tape 1 | 3M ™ High Performance Masking Tape 232, 3M Corporation, Maplewood, MN |
| Tape 2 | 3M ™ Scotch 845 Book Tape, 3M Corporation, Maplewood, MN |
| Tape 3 | 3M ™ Scotch Blue Painter's Tape 2090, 3M Corporation, Maplewood, MN |
| Tape 4 | 3M ™ Scotch Transparent Green Tape, 3M Corporation, Maplewood, MN |
| 3SAB PET | 2-mil (0.058-millimeter) thick polyester terephthalate (PET) film, which has |
| | one side chemically treated or primed to improve the adhesion of silicone |
| | coatings, commercially available under the trade designation |
| | “HOSTAPHAN2 3SAB” from Mitsubishi Polyester Film, Greer, SC. |

### Test Methods

### Peel Adhesion Strength

Peel adhesion strength was measured at an angle of 90° using an IMASS SP-200 slip/peel tester (IMASS, Incorporated, Accord, MA) at a peel rate of 229 centimeters/minute (90 inches/minute). Glass test panels measuring 25.4 centimeters by 12.7 centimeters (10 inches by 5 inches) were cleaned by wiping them with isopropanol using a lint-free tissue and allowing them to air dry for 30 minutes prior to clamping the test panels to the test stage of the peel tester. Tape samples measuring approximately 1.3 centimeters by 20 centimeters (0.5 inch by 8 inches) were then applied to the cleaned test panels with the adhesive side in contact with the test panel. The tape samples were then rolled over using a 2.0-kilogram (4.5-pound) rubber roller one time forward and backward. The taped panels were stored and tested at 23° C. and 50% relative humidity (RH). Testing was conducted between 1 and 8 hours after preparation. Three taped panels were evaluated and the average peel adhesion strength of the total number of panels tested was reported. Results were obtained in grams/inch.

### 90° Angle Release Force

The indicated testing tape was applied to the release films or release formulation coated paper with the adhesive of the tape in contact with the release films or release formulation coated paper. The resulting laminates were then rolled over using a 2.0-kilogram (4.5-pound) rubber roller one time forward and backward and aged for 7 days at 23° C. or 50° C. prior to testing for release adhesion strength. Next, a double-sided foam tape (3M Double Coated Urethane Foam Tape 4008, a 0.125-inch-thick open-cell, flexible urethane foam tape, obtained from 3M Company, Maplewood, MN) was applied to the platen of a peel tester (Slip/Peel Tester, Model 3M90, Instrumentors, Incorporated, Strongsville, OH). A sample of the release liner/tape laminate, measuring 2.54 centimeters by approximately 20 centimeters (1 inch by 8 inches), was then applied to the exposed foam tape surface such that the exposed surface of the tape contacted the foam tape. This was rubbed down using light thumb pressure followed by rolling over it with a 2.0-kilogram (4.5-pound) rubber roller one time forward and backward. The tape was then removed from the release liner at an angle of 90° at a rate of 229 centimeters/minute (90 inches/minute). Results were obtained in grams/inch. Three laminates were evaluated and the average release adhesion strength of the total number of laminates tested was reported.

### % Readhesion

The effect of extractable materials in the release coating of the release liners on the peel adhesion strength of adhesive tapes which contacted the liners was evaluated as follows. After evaluating release liners for their release force, the tape was removed from the foam tape and evaluated for its re-adhesion peel strength as described the “Peel Adhesion Strength” test method above. This results from this test were recorded as “Readhesion Peel Strength”.

In addition, a tape sample contacted with release films or release formulation coated paper derived from “silicone additive free” formulation described herein as control formulation was also evaluated for its peel adhesion strength. These results were recorded as “Initial Peel Adhesion Strength”. This test was a measure of the effect of any extractable transferred from the release films or release formulation coated paper to the adhesive layer of the tape on the peel adhesion strength of the tape.

It is desirable that there be minimal differences between the initial and re-adhesion peel strength values. Readhesion peel strengths were used to calculate a % Readhesion as follows: Re-adhesion (%)=(Readhesion Peel Strength/Initial Peel Adhesion Strength)×100.

### EXAMPLES

### Preparation of Ethylene Vinyl Alcohol (EVA) Copolymer Release Films

A 10 wt. % solution of WSP-1 was prepared by mixing 100 g of WSP-1 in 900 g of deionized water and heating the mixture at 60° C. for 24 hours. Thereafter, desired amount of silicone additive was mixed with the above mixture at 60° C. for 1 hour. The resulting formulation was coated with a knife coater onto a 3SAB PET film and dried at 120° C. for 10 minutes. The resulting EVA release film was peeled from the 3SAB PET film and used for the release/readhesion testing.

### Preparation and Coating of Ethylene Vinyl Alcohol (EVA) Copolymer Release Formulation

A 5 wt. % solution of WSP-1 was prepared by mixing 50 g of WSP-1 in 450 g of deionized water and heating the mixture at 60° C. for 24 hours. Thereafter, desired amount of silicone additive was mixed with the above mixture at 60° C. for 1 hour. The resulting formulation was coated onto the yellow Post-it note paper backing with a #5 Mayer Rod and dried in an oven at 120° C./30 seconds.

TABLE 2
Release data for EVA release films aged
at 23° C. for 7 days with Tape 1

| | | | 90° | | |
|---|---|---|---|---|---|
| | | Silicone | Release | Peel | Peel |
| | Silicone | Additive | Force | Adhesion | Readhesion |
| Example # | Additive | (wt %) | (g/in) | (g/in) | (%) |
| CE-1 | N/A | N/A | 954.8 | 1153.0 | 100 |
| E1 | PDMS-1 | 5 | 42.3 | 1126.5 | 97.7 |
| E2 | PDMS-1 | 10 | 15.48 | 1050.4 | 91.1 |
| CE-2 | PDMS-2 | 5 | 882.8 | 1144.9 | 99.3 |
| CE-3 | PDMS-2 | 10 | 769.6 | 1151.8 | 99.9 |
| E3 | PDMS-4 | 5 | 60.6 | 1101.1 | 95.5 |

TABLE 3
Release data for EVA release films aged
at 50° C. for 7 days with Tape 1

| | | | 90° | | |
|---|---|---|---|---|---|
| | | Silicone | Release | Peel | Peel |
| | Silicone | Additive | Force | Adhesion | Readhesion |
| Example # | Additive | (wt %) | (g/in) | (g/in) | (%) |
| CE-1 | N/A | N/A | 857.9 | 1101.0 | 100 |
| E1 | PDMS-1 | 5 | 89.5 | 1061.4 | 96.4 |
| E2 | PDMS-1 | 10 | 45.3 | 1055.9 | 95.9 |
| CE-2 | PDMS-2 | 5 | 842.2 | 1095.5 | 99.5 |
| CE-3 | PDMS-2 | 10 | 759.1 | 1090.0 | 99.0 |
| E3 | PDMS-4 | 5 | 101.0 | 1082.3 | 98.3 |

TABLE 4
Release data for EVA release films aged
at 23° C. for 7 days with Tape 2

| | | | 90° | | |
|---|---|---|---|---|---|
| | | Silicone | Release | Peel | Peel |
| | Silicone | Additive | Force | Adhesion | Readhesion |
| Example # | Additive | (wt %) | (g/in) | (g/in) | (%) |
| CE-1 | N/A | N/A | 1206.7 | 1221.0 | 100 |
| E1 | PDMS-1 | 5 | 181.9 | 1199.0 | 98.2 |
| E2 | PDMS-1 | 10 | 112.9 | 1167.3 | 95.6 |
| CE-2 | PDMS-2 | 5 | 869.5 | 1208.8 | 99 |
| CE-3 | PDMS-2 | 10 | 800.1 | 1194.1 | 97.8 |
| E3 | PDMS-4 | 5 | 200.2 | 1189.3 | 97.4 |

TABLE 5
Release data for EVA release films aged
at 50° C. for 7 days with Tape 2

| | | | 90° | | |
|---|---|---|---|---|---|
| | | Silicone | Release | Peel | Peel |
| | Silicone | Additive | Force | Adhesion | Readhesion |
| Example # | Additive | (wt %) | (g/in) | (g/in) | (%) |
| CE-1 | N/A | N/A | 950.6 | 1147.0 | 100 |
| E1 | PDMS-1 | 5 | 167.6 | 1128.6 | 98.4 |
| E2 | PDMS-1 | 10 | 154.0 | 1090.8 | 95.1 |
| CE-2 | PDMS-2 | 5 | 769.4 | 957.7 | 83.5 |
| CE-3 | PDMS-2 | 10 | 877.0 | 983.0 | 85.7 |
| E3 | PDMS-4 | 5 | 189.7 | 1120.6 | 97.7 |

TABLE 6
Release data for EVA release formulation coated
paper aged at 23° C. for 7 days with Tape 3

| | | | 90° | | |
|---|---|---|---|---|---|
| | | Silicone | Release | Peel | Peel |
| | Silicone | Additive | Force | Adhesion | Readhesion |
| Example # | Additive | (wt %) | (g/in) | (g/in) | (%) |
| CE-2 | N/A | N/A | * | 935.0 | 100 |
| E4 | PDMS-1 | 10 | 116.4 | 860.2 | 92.0 |
| E5 | PDMS-3 | 10 | 273.2 | 630.2 | 67.4 |

* layer of paper tore due to strong adhesion between paper and adhesive tape

TABLE 7
Release data for EVA release formulation coated
paper aged at 50° C. for 7 days with Tape 3

| | | | 90° | | |
|---|---|---|---|---|---|
| | | Silicone | Release | Peel | Peel |
| | Silicone | Additive | Force | Adhesion | Readhesion |
| Example # | Additive | (wt %) | (g/in) | (g/in) | (%) |
| CE-2 | N/A | N/A | * | 874 | 100 |
| E4 | PDMS-1 | 10 | 152.1 | 792.7 | 90.7 |
| E5 | PDMS-3 | 10 | 484.1 | 596.9 | 68.3 |

* layer of paper tore due to strong adhesion between paper and adhesive tape

TABLE 8
Release data for EVA release formulation coated
paper aged at 23° C. for 7 days with Tape 4

| | | | 90° | | |
|---|---|---|---|---|---|
| | | Silicone | Release | Peel | Peel |
| | Silicone | Additive | Force | Adhesion | Readhesion |
| Example # | Additive | (wt %) | (g/in) | (g/in) | (%) |
| CE-2 | N/A | N/A | 214.8 | 992.0 | 100 |
| E4 | PDMS-1 | 10 | 104.7 | 893.8 | 90.1 |
| E5 | PDMS-3 | 10 | 535.2 | 328.4 | 33.1 |

TABLE 9
Release data for EVA release formulation coated
paper aged at 50° C. for 7 days with Tape 4

| | | | 90° | | |
|---|---|---|---|---|---|
| | | Silicone | Release | Peel | Peel |
| | Silicone | Additive | Force | Adhesion | Readhesion |
| Example # | Additive | (wt %) | (g/in) | (g/in) | (%) |
| CE-2 | N/A | N/A | 261.6 | 918.0 | 100 |
| E4 | PDMS-1 | 10 | 135.1 | 877.6 | 95.6 |
| E5 | PDMS-3 | 10 | 686.3 | 300.2 | 32.7 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, 10 given to enable one of ordinary skill in the art to practice the claimed disclosure, is not to be construed as limiting the scope of the disclosure, which is defined by the claims and all equivalents thereto.

1. A release liner comprising a layer of a composition comprising a) a polymeric material having at least one hydrogen atom covalently bonded to an oxygen atom, a nitrogen atom, or a sulfur atom; and b) a silicone polyether comprising 80 wt. % or greater of at least one of polyoxoethylene units or polyoxopropylene units, wherein the polymeric material is present in an amount of 90 to 99.5 wt. %, based on the weight of the combined polymeric material and silicone polyether, and wherein the polymeric material and the silicone polyether are not covalently bonded to each other.

2. A release liner comprising a substrate having a first major surface and an opposing second major surface; and a coating disposed on at least a portion of the first major surface of the substrate, wherein the coating comprises a composition comprising a) polymeric material having at least one hydrogen atom covalently bonded to an oxygen atom, a nitrogen atom, or a sulfur atom; and b) a silicone polyether comprising 80 wt. % or greater of at least one of polyoxoethylene units or polyoxopropylene units, wherein the polymeric material is present in an amount of 90 to 99.5 wt. %, based on the weight of the combined polymeric material and silicone polyether, and wherein the polymeric material and the silicone polyether are not covalently bonded to each other.

3. The release liner of claim 1 or claim 2, wherein the silicone polyether is composed of 75 wt. % or greater, 80 wt. % or greater, 85 wt. % or greater[[,]] or 90 wt. % or greater, of at least one of polyoxoethylene units or polyoxopropylene units.

4. The release liner of any of claims claim 1484, wherein the silicone polyether has the structure of Formula (I) or Formula (II): 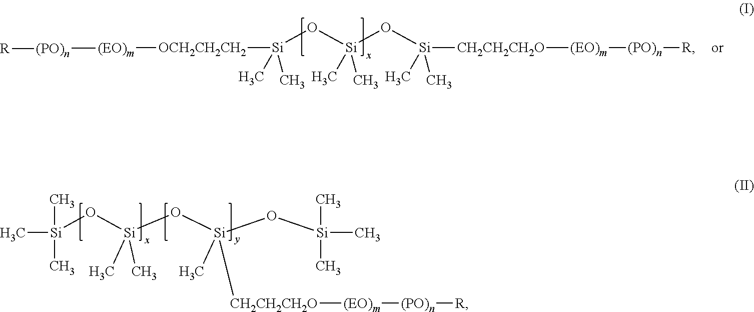
wherein R is independently selected from C1-C10 linear or branched alkyl groups, methoxy, ethoxy, isopropoxy, isobutoxy, halogens selected from Cl, Br, and I, C6-C12 aromatic groups, hydroxy, —CH₂—OH, —CH₂CH₂—OH, or —CH₂CH₂—OCH₃; EO is —(CH₂—CH₂—O)—; PO is —(CH₂—CHCH₃—O)—; n and m are independently selected from integers between 0 and 500, with the proviso that at least one n or at least one m is selected from integers between 1 and 500; and x and y are independently selected from integers between 1 and 5000.

5. The release liner of claim 1, to wherein the silicone polyether comprises a poly(dimethylsiloxane-co-ethyleneoxide) AB block copolymer with 82 wt. % or 85 wt. % polyoxoethylene units.

6. The release liner of claim 1, wherein the silicone polyether is present in an amount of 0.5 wt. % to 10 wt. %, based on the weight of the combined polymeric material and silicone polyether.

7. The release liner of claim 1, wherein the polymeric material is present in an amount of 95 to 99.5 wt. %, based on the weight of the combined polymeric material and silicone polyether.

8. The release liner of claim 1, wherein the polymeric material comprises at least one of polyvinyl alcohol, polyvinyl acetate, ethylene vinyl acetate, or ethylene vinyl alcohol.

9. (canceled)

10. The release liner of claim 1, comprising hydrogen bonding between at least a portion of the polymeric material and at least a portion of the silicone polyether.

11. The release liner of claim 1, wherein the layer or the coating is writable.

12. The release liner of claim 2, wherein the substrate is present and comprises paper or a polymeric film.

13. An article comprising a release liner of claim 1, the release liner having a first major surface comprising the layer or the coating; and an adhesive layer disposed on at least a portion of the first major surface of the release liner.

14. The article of claim 13, wherein the adhesive layer comprises an acrylic adhesive, a silicone adhesive, a rubber adhesive, or a urethane adhesive.

15. The article of claim 13, wherein the adhesive layer comprises a pressure sensitive adhesive.
